(19) United States
(12) Patent Application Publication
(10) Pub. No.: US 2026/0095815 A1
(43) Pub. Date: Apr. 2, 2026

(54) SYSTEMS AND METHODS OF QUALITY OF SERVICE NEGOTIATION FOR APPLICATIONS

(71) Applicant: Meta Platforms Technologies, LLC, Menolo Park, CA (US)

(72) Inventors: Jiansong Wang, Lincroft, NJ (US); Dong Zheng, Saratoga, CA (US); Ping Wang, Redmond, WA (US); Qi Qu, Redmond, WA (US)

(21) Appl. No.: 18/118,225

(22) Filed: Mar. 7, 2023

Related U.S. Application Data
(60) Provisional application No. 63/319,016, filed on Mar. 11, 2022.

(51) Int. Cl. H04W 28/24; H04W 28/02; H04W 76/10

(52) U.S. Cl. CPC H04W 28/24; H04W 28/084; H04W 76/10

(57) ABSTRACT

A wireless device may have at least one processor and a communication interface configured to communicate with a server device. The at least one processor and the communication interface may send, through a service control function, a first service request for initiating a service. The first service request may include an address of the server device and first quality of service (QOS) information relating to the service. The at least one processor and the communication interface may receive, through the service control function, a first session request for establishing a session relating to the service. The first session request may be initiated by the server device and include negotiated QoS information relating to the session.

### CROSS-REFERENCE TO RELATED APPLICATION

This application claims priority to U.S. Provisional Ser. No. 63/319,016 filed on Mar. 11, 2022, which is incorporated by reference herein in its entirety for all purposes.

### FIELD OF DISCLOSURE

The present disclosure is generally related to communications, including but not limited to systems and methods for an application (e.g., OTT (Over-The-Top) application) to negotiate with a network and a server to support low latency quality of service (QoS).

### BACKGROUND

Artificial reality such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a wireless device including at least one processor and a communication interface configured to communicate with a server device. The at least one processor and the communication interface may be configured to send, through a service control function, a first service request for initiating a service. The first service request may include an address of the server device and first quality of service (QoS) information relating to the service. The at least one processor and the communication interface may be configured to receive, through the service control function, a first session request for establishing a session relating to the service. The first session request may be initiated by the server device and include negotiated QoS information relating to the session.

In some embodiments, in response to the first session request, the at least one processor and the communication interface may be configured to send a session response indicating that the session has been established according to the first session request.

In some embodiments, in sending the first service request, the at least one processor and the communication interface may be configured to send the first service request to a management function, the first service request causing the management function to generate a second service request including second QoS information based at least on the first QoS information included in the first service request and send the second service request to the service control function. The second service request may cause the service control function to generate a third service request including third QoS information based at least on the second QoS information included in the second service request and send the third service request to the server device. The third service request may cause the server device to determine the negotiated QoS information based at least on the third QoS information included in the third service request.

In some embodiments, in sending the service request, the at least one processor and the communication interface may be configured to send the first service request directly to the server device, the first service request causing the server device to generate a second session request including the first QoS information included in the first service request and send the second session request to the service control function. The second session request may cause the service control function to generate a third session request including the first QoS information included in the second session request and send the third session request to a management function. The third session request may cause the management function to generate the first session request including the negotiated QoS information based at least on the first QoS information included in the third session request and send the first session request to the wireless device.

In some embodiments, the at least one processor may be configured to detect user plane congestion. The at least one processor may be configured to determine a traffic pattern update based at least on the detected user plane congestion. The at least one processor and the communication interface may be configured to send, through a user plane function (UPF) to the server device, a first notification relating to the traffic pattern update. The first notification may cause the server device to generate a new traffic pattern based at least on the traffic pattern update and send, through the UPF to the wireless device, a second notification relating to the new traffic pattern.

Various embodiments disclosed herein are related to a method including sending, by a wireless device through a service control function, a first service request for initiating a service. The first service request may include an address of a server device and first quality of service (QoS) information relating to the service. The method may include receiving, by the wireless device through the service control function, a first session request for establishing a session relating to the service. The first session request may be initiated by the server device and include negotiated QoS information relating to the session.

In some embodiments, in response to the first session request, the wireless device may send a session response indicating that the session has been established according to the first session request.

In some embodiments, in sending the first service request, the wireless device may send the first service request to a management function, the first service request causing the management function to generate a second service request including second QoS information based at least on the first QoS information included in the first service request and send the second service request to the service control function. The second service request may cause the service control function to generate a third service request including third QoS information based at least on the second QoS information included in the second service request and send the third service request to the server device. The third service request may cause the server device to determine the negotiated QoS information based at least on the third QoS information included in the third service request.

In some embodiments, in sending the service request, the wireless device may send the first service request directly to the server device, the first service request causing the server device to generate a second session request including the first QoS information included in the first service request and send the second session request to the service control function. The second session request may cause the service control function to generate a third session request including the first QoS information included in the second session request and send the third session request to a management function. The third session request may cause the management function to generate the first session request including the negotiated QoS information based at least on the first QoS information included in the third session request and send the first session request to the wireless device.

In some embodiments, the wireless device may detect user plane congestion. The wireless device may determine a traffic pattern update based at least on the detected user plane congestion. The wireless device may send, through a user plane function (UPF) to the server device, a first notification relating to the traffic pattern update. The first notification may cause the server device to generate a new traffic pattern based at least on the traffic pattern update and send, through the UPF to the wireless device, a second notification relating to the new traffic pattern.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 illustrates a block diagram of an example system environment including a mobile network operator (MNO) network and a multiple-system operator (MSO) network, according to an example implementation of the present disclosure.

FIG. 5 is a diagram of an example communication system between a wireless device and a server device, according to an example implementation of the present disclosure.

FIG. 6 is a diagram of an example communication flow for service management in a control plane, according to an example implementation of the present disclosure.

FIG. 7 is a diagram of an example communication flow for service management in a control plane, according to another example implementation of the present disclosure.

FIG. 8 is a diagram of an example communication flow on usage of user plane capabilities in a user plane, according to an example implementation of the present disclosure.

FIG. 9 is a flowchart showing a process for an application to negotiate with a network and/or a server to support low latency QoS, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are systems and methods related to an application (e.g., OTT (Over-The-Top) application) to negotiate with a network and a server to support low latency quality of service (QoS). OTT applications may negotiate end-to-end (e2e) QoS with mobile network operator (MNO)/multiple service operator (MSO) last-mile networks. This present disclosure relates to a wireless device (e.g., user equipment (UE)) including at least one processor and a communication interface configured to communicate with a server device (e.g., OTT application server or AR (Augmented Reality)/XR (eXtended Reality) application server). The at least one processor and the communication interface may be configured to send, through a service control function (e.g., AR service control function (ARSCF)), a first service request for initiating a service (e.g., OTT service, AR/XR service). The first service request may include an address of the server device and first quality of service (QoS) information relating to the service. The at least one processor and the communication interface may be configured to receive, through the service control function, a first session request for establishing a session relating to the service (e.g., OTT service session, AR/XR service session). The first session request may be initiated by the server device and can include negotiated QoS information relating to the session.

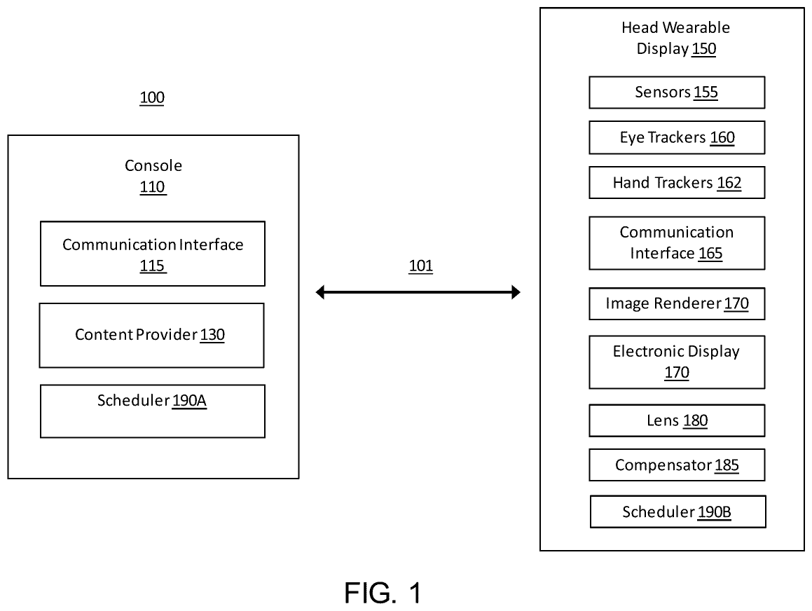

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10 %) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

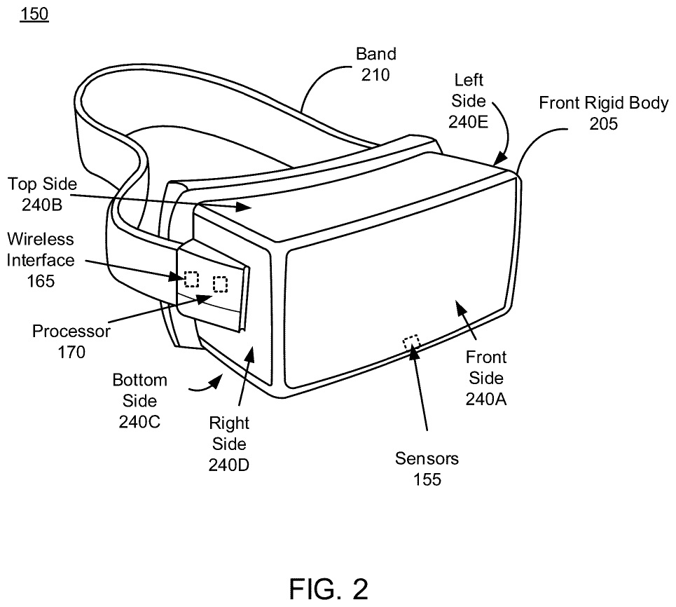

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

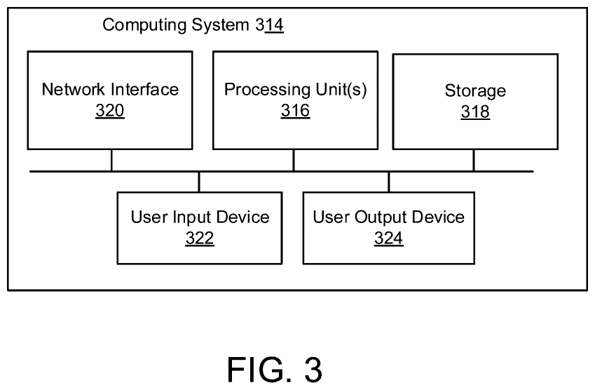

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

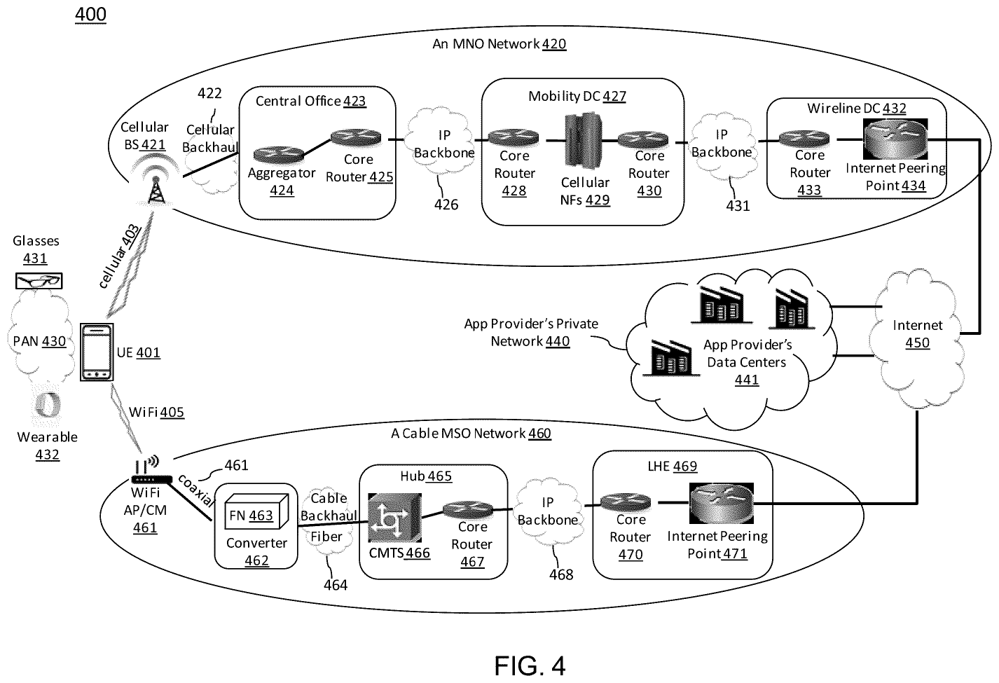

Telecommunications networks have been evolving over 100 years, but the basis of the telecommunications networks is still a connection-oriented and circuit-switched architecture in order to meet network quality of service (QoS) requirements related to voice communications. Internet and computer networks have been evolving over 6 decades, and the majority of networks are based on a connectionless packet-switched architecture in which there is no circuit setup procedure before sending a packet. Generally, QoS is not supported in a packet-switched network and there are a variety of access protocols between a host and the network (e.g., data over cable service interface specification (DOCSIS), Ethernet, Wi-Fi, worldwide interoperability for microwave access (WiMAX), Token Ring, Frame Relay, etc.). An example network topology is shown in FIG. 4.

FIG. 4 illustrates a block diagram of an example system environment 400 including UE 401, a personal area network (PAN) 430, a mobile network operator (MNO) network 420, a multiple-system operator (MSO) network (or cable MSO network) 420, and an application provider's private network 440. In the MNO network 420, there may be one or more access nodes (e.g., cellular base stations 421), a central office 423, a mobility data center 427, and a wireline data center 432. The central office 423 may include one or more aggregators 424 and one or more core routers 425 connected to the aggregators 424. The mobility data center 427 may include one or more core routers 428, one or more cellular network functions (NFs) 429 connected to the core routers 428, and one or more core routers 430 connected to the cellular NFs 429. The wireline data center 432 may include one or more core routers 433 and one or more internet peering points 434 connected to the core routers 433.

In the MSO network 420, there may be one or more access points or access nodes (e.g., Wi-Fi APs) or cable modems (CMs) 461, one or more converters 462 including one or more fiber nodes (FNs), a hub 465, and one or more local head end (LHE) offices 469. For example, a company may have no more than 20 LHE offices (e.g., 8-10 LHE offices). The hub 465 may include a cable modem termination system (CMTS) 466 and one or more core routers 467 connected to the CMTS 466. The LHE offices 469 may include one or more core routers 470 and one or more internet peering points 471 connected to the core routers 470. In the application provider's private network 440, there may be one or more application provider's data centers 441.

Referring to FIG. 4, a plurality of devices including wearable devices 431, 432 and the UE 401 may be wirelessly connected through the PAN 430. The UE 401 may be wirelessly connected to the cellular BSs 421 of the MNO network through a cellular wireless link 403, and wirelessly connected to the APs/CMs 461 of the cable MSO network 420 through a Wi-Fi link 405. The MNO network 420, the cable MSO network 460 and the application provider's private network 440 may be connected to each other through an internet 450 (e.g., the Internet).

In the MNO network 420, the cellular BS 421 may be connected to the aggregators 424 of the central office 423 through a cellular backhaul 422. For example, the backhaul 422 may terminate at the central office 423 which may be no more than 5 miles from home (e.g., 1.5 miles from a residential area). The aggregators 424 may aggregate traffic from the cellular BS 421 (e.g. aggregate traffic of 10-100 GB). The core routers 425 of the central office 423 may be connected to the core routers 428 of the mobility data center 427 through an IP backbone network 426. The IP backbone network 426 may have a centralized structure of backbone networks such that a telecommunication company has 20-30 backbone networks. The core routers 430 of the mobility data center 427 may be connected to the core routers 433 of the wireline data center 432 through an IP backbone network 431 which may be different from the IP backbone network 426. In some embodiments, the IP backbone network 431 may be the same as the IP backbone network 426. The internet peering points 434 may be connected to the internet 450.

In the MSO network 460, the APs/CMs 461 may be connected to the converters 462 through a coaxial cable/network 461. The converters 462 may be connected to the CMTS 466 of the hub 465 through a cable backhaul fiber 464. The core routers 467 of the hub 465 may be connected to the core routers 470 of the LHE offices 469 through an IP backbone network 468. The IP backbone network 468 may be different from the IP backbone network 426 and/or the IP backbone network 431. The internet peering point 471 of the LHE offices 469 may be connected to the internet 450.

As shown in FIG. 4, in an MNO network (e.g., MNO network 420), a base station (e.g., base station 421) may terminate a cellular radio protocol between a device (e.g., UE 401) and the base station. The base station may manage the transmission, reception and scheduling of user traffic. The base station may also enforce necessary QoS performance over a wireless (or air) interface. The cellular network functions inside mobility data centers (e.g. mobility data centers 427) may be core network functions that manage the transmission, reception and scheduling of the user traffic. The network functions may also enforce QoS performance inside a mobile core network (e.g., MNO network 420). Those core network functions may include mobility management entity (MME), packet data network gateway (PGW), policy and charging rules function (PCRF) for Long Term Evolution (LTE) and access and mobility management function (AMF), Session Management Function (SMF), Policy Control Function (PCF), user plane function (UPF) for 5G. The MNO network may be a cellular network, e.g., global system for mobile communications (GSM), universal mobile telecommunications system (UMTS), LTE, 5G. The MNO network may be a 3rd generation partnership project (3GPP) standard based network. The MNO network may be a connection-oriented network with centralized scheduling architecture for ubiquitous wide area communication access. The connection-oriented networks can minimize contentions, while having a complex structure.

In an MSO network (e.g., MSO network 460), a cable modem at home (e.g., AP/CM 461) may manage the transmission, reception and scheduling of the user traffic from connected devices, as well as over a DOCSIS interface towards a CMTS (e.g., CMTS 466) in an MSO hub (e.g., hub 465) and/or LHE offices (e.g., LHE offices 469). The core network of the MSO network may be generally a managed IP core network, like an enterprise network. The MSO network may be a broadband cable service network and may be a DOCSIS standard based home broadband network. The MSO network may be a packet-oriented and/or connectionless access network for local and/or enterprise area communication access. The MSO network may avoid collisions, e.g., using a random backoff mechanism, while providing no explicit signaling control protocol for user/session admission controls, as compared to the connection-oriented cellular networks. In the MSO network, QoS management may be minimal. For example, QoS management may be provided only for MSO provided VoIP (voice over IP) traffic and modem management traffic. All other user traffic may be treated as the “best effort” service. No explicit signaling control protocol may run in the MSO networks for user/session admission controls, as compared to the connection-oriented cellular networks.

Internet applications (e.g., messenger, online social media and social networking services like Facebook, Instagram), AR applications, AR/XR applications, etc. are referred to as OTT (Over-The-Top) applications by MNOs/MSOs, because such applications are not services provided an MNO/MSO network. OTT applications may need support for low latency QoS. For example, an AR application may not be a best-effort service and in some cases it may be beneficial to provide the guaranteed bandwidth and latency for a period of time. Another OTT application (e.g., AR/XR application) may be a broad web service that may be offered by many application/content providers. There is no widely accepted standards and/or practices for OTT application servers to signal their respective performance needs over the MNO/MSO networks. Thus, OTT applications may normally get a “best effort” network service in the MNO/MSO networks in the same manner as that in the Internet. The “best effort” network service may be acceptable for applications such as web services (HTTP services), file download services, etc. VoIP and video applications can “passively” estimate network conditions and adjust application behaviors when network impairments are assumed.

However, for AR/XR interactive applications, the critical network performance key performance indicator (KPI) is not just the network bandwidth availability but also network latency. In order to proactively control/manage the network QoS performance and acquire service at least better than the “best effort” services end-to-end, it would be beneficial to provide an e2e control protocol from AR/XR application servers to MNO/MSO respective network functions and then to user devices (e.g., UEs). In certain MNO networks, enhanced QoS services in LTE can be provided. The enhanced QoS services may be either static or dynamic. In the static cases, a device and the network may be provisioned with a special LTE APN (Access Point Name) such that an eligible/authorized device could access higher QoS treatment through that APN, compared with the traffic on the general internet APN. In the dynamic cases, either (1) an eligible/authorized device, based on the network/event triggering conditions, could request the application servers to temporarily request QoS uplift in the MNO network on behalf of another device, or (2) an application operation center could request QoS uplift for a group of users in the MNO network during some period of time and/or due to certain events when necessary. Both methods may use or require a signaling interface or a signaling protocol from an application server into the MNO networks. This signaling interface/protocol has been implemented as a proprietary application interface, e.g., per MNO specific.

It would be beneficial for a flexible application-network signaling protocol and an enhanced user plane protocol to convey QoS requirements of an application from application servers (or “app servers”) to the network both (1) at an OTT session establishment time and (2) in the user data packet flow phases. There is also a need to build an OTT performance management ecosystem (e.g., AR performance management ecosystem) among device vendors, network equipment vendors, MNOs/MSOs, and application service providers.

To address this problem, an OTT application may negotiate with a network and a server to support low latency QoS (quality of service). When the network is MNO or MSO, a system may provide (1) a control plane API for a service control function to interface with policy and session management functions of the MNO/MSO network and OTT application functions to manage services between the network and an application domain, and/or (2) a user plane API that plans routing and manages congestion avoidance, packet drop precedence and low latency queuing to react network conditions in real time. Using the systems and methods described herein, a signaling service can be established between a device with an OTT application thereon (UE), the network and an OTT application server (or “app server”) to negotiate the overall QoS requirements/policies for the OTT application, thereby providing a guaranteed bandwidth and latency for a desired period of time. OTT applications may provide an AR service (or AR/XR service) which is not a best-effort service and in some cases may involve/require a guaranteed bandwidth and latency for a period of time. The AR service may be a broad web service that can be offered by many application/content providers, not just MNO/MSO itself.

In one approach, a system may provide a flexible application-network signaling protocol and an enhanced user plane protocol to convey the application QoS requirements from application servers to the network at a session establishment time (e.g., AR session establish time) and/or at user data packet flow phases. In some embodiments, the system may establish and/or support a performance management ecosystem (e.g., an AR performance management ecosystem) among device vendors, network equipment vendors, MNOs/MSOs and application service providers.

In one approach, a system may utilize a client-server based communication architecture and can establish a signaling service between app-on-device (e.g., AR/XR app running on UE), network and app-on-server (e.g., AR/XR app running on an application server) to negotiate the overall QoS requirements/policies for an OTT application (e.g., AR/XR app). In some embodiments, the system may utilize a transport protocol standard and extension headers to convey granular adjustments in the packet forwarding paths. The granular adjustments may be per application service flow basis (e.g., separate adjustments for voice, video, depth and auxiliary traffic flows) to process traffic with higher priority when network congestion occurs. The system may drop traffic based on a priority of the traffic (e.g., a lower priority traffic may be dropped). For example, a VoIP traffic flow may have a priority higher than a priority of a video traffic flow, and a 2D image traffic flow has a priority higher than a priority of a 3D image traffic flow.

In one approach, in a control plane, a system may include a service control function (e.g., AR Service Control Function (ARSCF)) which can sit or be located at the boundary of a MNO/MSO network between the MNO/MSO network and an application service domain. In some embodiments, the ARSCF may be a network function configured to communicate with an application server or other network functions (e.g., serving policy and session management functions or “P/S managements”) through an application program interface (API; e.g., open APIs). The API may be a network interface type that is used by two network functions to exchange information. In some embodiments, the ARSCF can communicate with a 5G network (e.g., 5G NEF function) through an API. In some embodiments, the ARSCF may be managed or implemented by either an MNO/MSO or an application service provider or even a third party broker. At one side, the ARSCF may interface with policy and session management functions (e.g., P/S managements) of MNO/MSO to manage services (e.g., AR/XR services) inside the MNO/MSO network. On the other side, the ARSCF may interface with application functions (e.g., AR/XR application functions) to manage the services between a MNO/MSO network and an application domain (e.g., AR/XR application domain).

In some embodiments, in the control plane, a wireless device (e.g., UE) and/or an AR/XR application running on the wireless device may perform end-to-end AR service management with an application server and/or an AR/XR application running on the application server. In some embodiments, the end-to-end AR service management may be performed by communications between UE, access nodes, P/S management, ARSCF, and the application server. The UE may communicate with the access nodes using a signaling/interface between the UE and the access nodes. The access nodes may communicate with the P/S management using an internal signaling/interface in the MNO/MSO network. The P/S management may communicate with the ARSCF using open APIs. The ARSCF may communicate with the application server using open APIs.

In one approach, in a user plane, during information data transmission phases (e.g., transmission of AR/XR information/data) the system may perform a quick and efficient method to plan routing, manage congestion avoidance, packet drop precedence and/or low latency queuing, in response to the network conditions in real time. The user plane method may be performed/implemented based on an IP network layer. In some embodiments, the user plane method may be performed/implemented based on a transport layer. The user plane method may be provided/implemented as APIs.

In some embodiments, in the user plane, a wireless device (e.g., UE) and/or an AR/XR application running on the wireless device may perform radio bearer QoS management with radio access points using a signaling/interface between the UE and the radio access nodes. The radio access nodes may perform MNO/MSO backhaul/backbone QoS management with a user plane function (UPF) through MNO/MSO internal packet flows. The UPF may transmit/receive one or more IP packet flows to/from the application server (and the AR/XR application running thereon) using an IP core network. The one or more IP packet flows may include traffic of video, audio, depth for a volumetric calling.

In one approach, a wireless device (e.g., UE) may initiate a service session (e.g., an AR session or an AR/XR session) by sending a service request (e.g., a request for an AR service or AR/XR service) to an application server (e.g., AR application server or AR/XR application server). The application server may send a session establish request (e.g., an AR or AR/XR session establishment request) to UE ARSCF and the P/S management (function).

In one approach, UE may initiate an AR session by sending an AR service request with an expected QoS to a policy/session management function (sometimes referred to as P/S Management, or management function). The P/S Management may send an AR service request with a negotiated QoS through a control plane API to the ARSCF. The ARSCF may send an AR service request, also through a control plane API, with a further negotiated QoS to an App server. The App server may send an AR session establishment request with a finally negotiated QoS to the ARSCF through the control plane API. The ARSCF may forward the AR session establishment request with the finally negotiated QoS to the P/S management. The P/S Management may send the AR session establishment request to establish the AR session to UE.

In some embodiments, a system may perform a communication flow (or call flow) for service management (e.g., initiating an AR service and an AR service session) in a control plane. At a first step, in order to initiate and deliver AR services over an MNO/MSO network with an expected/desired QoS, application servers (e.g., AR application server) may operate to register/subscribe to neighbor ARSCFs based on previously known or predetermined relations. Registration/subscription of AR applications may include registration/subscription of AR service types, AR use cases supported, expected QoS ranges for different use cases, server authentication token, authentication methods, server locality, etc. For example, an ARSCF and an AR application (or an application server on which the AR application is running) may perform registration/subscription based on subscribed AR services, service level agreement (SLA) negotiation, authentication/authorization between the ARSCF and the AR application. As a result of the registration/subscription, the ARSCF and the AR application can obtain/achieve an SLA for each AR service type/use case, as well as a trusted relation between the ARSCF and the AR application (or the application server).

At a second step, ARSCFs may register/subscribe with P/S managements inside the MNO/MSO network. Registration/subscription of ARSCFs may include registration/subscription of AR service types, AR use cases supported, expected QoS ranges for different use cases, ARSCF authentication token, authentication methods, ARSCF locality, etc. For example, an ARSCF and a P/S management may perform registration/subscription based on subscribed AR services, service level agreement (SLA) negotiation, authentication/authorization between the P/S management and the ARSCF. As a result of the registration/subscription, the ARSCF and the P/S management can obtain/achieve an SLA for each AR service type/use case, as well as a trusted relation between the ARSCF and the P/S management.

In some embodiments, a system may perform an AR session initiation by communications between a wireless device (e.g., UE), access nodes, a P/S management, an ARSCF, and/or an AR application server in a control plane. At a third step, the UE may initiate an AR session by sending an AR service request to the P/S management. The AR service request may include an AR service type, an expected QoS, supported service modes, an address of the application server, one or more user plane capabilities supported, etc. The supported service modes can be different resolution levels that the UE app (e.g., AR application running on the UE) supports during the AR session in order to adapt the network conditions. In some embodiments, the supported service modes can include other user traffic adaptive information. The application server address can be information configured on the device (UE) or information obtained by causing the network to detect/discover/figure out the “best” application servers based on server availability, the AR service type, the expected QoS, the supported service modes, and/or the one or more user plane capabilities supported. The one or more user plane capabilities supported can refer to those capabilities that can indicate, for example, capabilities for supporting (1) DiffServ, (2) explicit congestion notification, (3) low latency low loss scalable throughput (LAS) architecture, (4) traffic pattern updates in the user plane, and so on. The traffic pattern updates can be done by defining an optional IP header or a new Internet Control Message Protocol (ICMP) message exchange procedure defined by standards communities.

At a fourth step, the serving P/S management may decide/determine a common set of capabilities and service modes between the UE and the MNO/MSO network, based on the MNO/MSO network policies, session policies, network QoS capabilities, network user plane capabilities, and/or network AR supportability. Next, the P/S management may send an AR service request to a selected/chosen ARSCF. The AR service request may include a UE/app (e.g., AR application) correlation identifier (ID), a negotiated service type, negotiated QoS, negotiated service modes, the address of the application server, negotiated one or more user plane capabilities, and so on. The ARSCF can be selected/chosen based on the application server address from the UE or a network configuration. The UE/app correlation ID may be used by the ARSCF and the application server (or application server instance) to correlate any future updates for serving the UE/app in this AR session.

At a fifth step, the ARSCF may decide/determine a common set of capabilities and service modes between the UE and the MNO/MSO network based on local policies of the ARSCF, known/predetermined network QoS capabilities, known/predetermined network user plane capabilities, known/predetermined network AR supportability, and so on. Next, the ARSCF may send an AR service request to a selected/chosen application server (or a domain thereof). The AR service request may include the UE/app correlation ID, a negotiated service type, a negotiated QoS, negotiated service modes, an MNO/MSO identifier (ID), negotiated one or more user plane capabilities supported, and so on. An application server can be selected/chosen based on the application server address from the UE or previous server registration/subscription records. The UE/App correlation ID may be used by the ARSCF and the serving application server (or application server instance) to correlate any future updates for serving the UE/app in this AR session. The MNO/MSO ID can be used to provide an application service provider (of the AR application) with information on which MNO/MSO is serving the UE AR session at this moment (e.g., when the ARSCF sends the AR service request to the application server). The MNO/MSO ID can be used for tracing records and service stats analysis.

At a sixth step, the application server may determine whether to authorize the AR service, and in response to determining that the application server authorizes the AR service, the application server may request that the network (e.g., MNO/MSO network) establish the AR session with final negotiated QoS information, the negotiated service modes to be used in the session, the negotiated user plane capabilities to be used in the AR session, etc. The application server may send an AR session establishment (EST) request to the ARSCF. The AR session EST request may include a service that is authorized, the UE/app correlation ID, a final negotiated service type, a final negotiated QoS, final negotiated service modes, an identifier (ID) of an application server instance, user plane capability requested, etc. The application server instance ID (or application service instance ID) can identify the actual server instance that is assigned for this AR session. The application server instance ID can be useful for tracing records and service stats analysis.

At a seventh step, the ARSCF may send/forward an AR session establishment (EST) request to the serving P/S management. The AR session EST request may include the service authorized, the UE/app correlation ID, the final negotiated service type, the final negotiated QoS, the final negotiated service modes, the application server instance ID, the user plane capability requested, etc. The application server instance ID (or application service instance ID) may be recorded down for further communications. But information on detailed QoS assignments, user plane capabilities to be used and other AR use cases related parameters (e.g., parameters of the AR session EST request) may be used by the device (e.g., UE) and underlying network functions to serve the AR session.

At an eighth step, the P/S management may request that the access network (e.g., access nodes) and the device (e.g., UE) establish the AR session with the final negotiated QoS information, the service modes to be used in the AR session, the user plane capabilities to be used in the AR session, etc. For example, the P/S management may send to the access nodes an AR session EST request including the UE/app correlation ID, the final negotiated AR service type, the final negotiated QoS, additional service modes as finally negotiated, the user plane capability requested, etc. The P/S management may send to the UE an AR session EST request including the AR service authorized, the final negotiated AR service type, the final negotiated QoS, the final service modes, the application server instance ID, the user plane capability requested, etc.

At a ninth step, the access network (e.g., access nodes) and the device (e.g., UE) may confirm the AR session setup and the user plane capabilities to be used, and can send the confirmation to the P/S management. For example, the access nodes may send a session establishment confirmation indicating that user plane capability (e.g., the user plane capability requested) is confirmed. The UE may send a session establishment confirmation indicating that user plane capability (e.g., the user plane capability requested) is confirmed. At a tenth step, the P/S management may confirm the session AR session setup and the user plane capabilities to be used, and can send to the ARSCF a confirmation indicating that the AR session is established with the UE/app correlation ID, the application server instance ID, the user plane capability confirmed. At an eleventh step, the ARSCF may confirm the session AR session setup and the user plane capabilities to be used, and can send to the application server instance a confirmation indicating that the AR session is established with the UE/app correlation ID, the application server instance ID, the user plane capability confirmed.

In one approach, UE may initiate an AR session by sending an AR service request directly to an App server. The App server may send an AR session establishment request with a requested QoS to the ARSCF through the control plane API. The ARSCF may forward the AR session establishment request with the requested QoS to the P/S Management. The P/S Management may send the AR session establishment request with a negotiated QoS to establish the AR session to UE.

In some embodiments, a system may perform a communication flow (or call flow) for service management (e.g., initiating an AR service and an AR service session) in a control plane. At a first step, in order to initiate and deliver AR services over an MNO/MSO network with an expected/desired QoS, application servers (e.g., AR application server) may operate to register/subscribe to neighbor ARSCFs based on previously known or predetermined relations. Registration/subscription of AR applications may include registration/subscription of AR service types, AR use cases supported, expected QoS ranges for different use cases, server authentication token, authentication methods, server locality, etc. For example, an ARSCF and an AR application (or an application server on which the AR application is running) may perform registration/subscription based on subscribed AR services, service level agreement (SLA) negotiation, authentication/authorization between the ARSCF and the AR application. As a result of the registration/subscription, the ARSCF and the AR application can obtain/achieve an SLA for each AR service type/use case, as well as a trusted relation between the ARSCF and the AR application (or the application server).

At a second step, ARSCFs may register/subscribe with P/S managements inside the MNO/MSO network. Registration/subscription of ARSCFs may include registration/subscription of AR service types, AR use cases supported, expected QoS ranges for different use cases, ARSCF authentication token, authentication methods, ARSCF locality, etc. For example, an ARSCF and a P/S management may perform registration/subscription based on subscribed AR services, service level agreement (SLA) negotiation, authentication/authorization between the P/S management and the ARSCF. As a result of the registration/subscription, the ARSCF and the P/S management can obtain/achieve an SLA for each AR service type/use case, as well as a trusted relation between the ARSCF and the P/S management.

In some embodiments, a system may perform an AR session initiation by communications between a wireless device (e.g., UE), access nodes, a P/S management, an ARSCF, and an AR application server in a control plane. At a third step, the UE may initiate an AR session by sending an AR service request to the AR application server. The AR service request may include a set of parameters including a UE/app (e.g., AR application) correlation identifier (ID), an AR service type, supported service modes, an address of the application server, one or more user plane capabilities supported, etc. Application servers may know what QoS is required for an application. Hence, the UE may not provide QoS information to the AR application at this step. A negotiation between app server and network may happen after this step. The network (e.g., ARSCF, the P/S management, and/or access nodes) may obtain the application QoS requirements from the application server. The set of parameters may be derived by the UE. The UE/App correlation ID may be used in future by the application server and the network (e.g., MNO/MSO network) to correlate the AR service request by the UE in the subsequent messages. The supported service modes can be different resolution levels that the UE app (e.g., AR application running on the UE) supports during the AR session in order to adapt the network conditions. In some embodiments, the supported service modes can include other user traffic adaptive information. The application server address can be information configured on the device (UE). The one or more user plane capabilities supported can refer to those capabilities that can indicate, for example, capabilities for supporting (1) DiffServ, (2) explicit congestion notification, (3) low latency low loss scalable throughput (LAS) architecture, (4) traffic pattern updates in the user plane, and so on. The traffic pattern updates can be done by defining an optional IP header or a new Internet Control Message Protocol (ICMP) message exchange procedure defined by standards communities.

At a fourth step, the application server may determine whether to authorize the AR service, and in response to determining that the application server authorizes the AR service, the application server may request that the network (e.g., MNO/MSO network) establish the AR session with requested QoS information, requested service modes to be used in the session, requested user plane capabilities to be used in the AR session, etc. The application server may send an AR session establishment (EST) request to the ARSCF. The AR session EST request may include a service authorized, the UE/app correlation ID, the requested service type, the requested QoS, the requested service modes, an identifier (ID) of an application server instance, the requested user plane capability, etc. The application server instance ID can identify the actual server instance that is assigned for this AR session. The application server instance ID can be useful for tracing records and service stats analysis.

At a fifth step, the ARSCF may send/forward an AR session establishment (EST) request to the serving P/S management. The AR session EST request may include the service authorized, the UE/app correlation ID, the requested AR service type, the requested QoS, the requested service modes, the application server instance ID, the user plane capability requested, etc. The application server instance ID (or application service instance ID) may be recorded down for further communications. But information on the requested QoS, the requested user plane capabilities, and other AR use cases related parameters (e.g., parameters of the AR session EST request) may be used by the device (e.g., UE) and underlying network functions to serve the AR session.

At a sixth step, the P/S management may request that the access network (e.g., access nodes) and the device (e.g., UE) establish the AR session with the negotiated QoS information to be used in the AR session, the negotiated service modes to be used in the AR session, the negotiated user plane capabilities to be used in the AR session, etc. For example, the P/S management may send to the access nodes an AR session EST request including the UE/app correlation ID, the AR service type, the negotiated QoS, the negotiated service modes, the user plane capability requested, etc. The P/S management may send to the UE an AR session EST request including the AR service authorized, the AR service type, the negotiated QoS, the service modes, the application server instance ID, the user plane capability requested, etc. These negotiated parameters may be based on (1) the parameters requested by the application server and (2) local policies inside the P/S management. In some embodiments, the P/S management may continue setting up the AR session first with the above-noted negotiated parameters to speed up the AR session establishment process. The P/S management may let/cause the application running on the device (UE) and the application running on the application server to decide whether the negotiated parameters are acceptable or not. Alternatively, the P/S management may negotiate directly with the application server back and forth before setting up the AR session in the network. In this case, however, the AR session setup may be delayed.

At a seventh step, the access network (e.g., access nodes) and the device (e.g., UE) may confirm the AR session setup and the user plane capabilities to be used, and send the confirmation to the P/S management. In some embodiments, if the UE does not accept the negotiated parameters in this step, the UE may reject the AR session establishment and does not send a confirmation to the P/S management. For example, the access nodes may send a session establishment confirmation indicating that user plane capability (e.g., the user plane capability requested) is confirmed. The UE may send a session establishment confirmation indicating that user plane capability (e.g., the user plane capability requested) is confirmed. At an eighth step, the P/S management may confirm the session AR session setup and the user plane capabilities to be used, and can send to the ARSCF a confirmation indicating that the AR session is established with the UE/app correlation ID, the application server instance ID, negotiated QoS, negotiated user plane capability, negotiated service modes, etc. The AR session establishment confirmation may include the negotiated parameters to inform the application server of what is established currently.

At a ninth step, the ARSCF may confirm the session AR session setup and the user plane capabilities to be used, and can send to the application server instance a confirmation indicating that the AR session is established with the UE/app correlation ID, the application server instance ID, a negotiated QoS, negotiated one or more user plane capabilities, negotiated service modes, etc. In some embodiments, at this stage, the application server may decide/determine whether the negotiated session parameters are acceptable or not. If the application server does not determine that the negotiated session parameters are acceptable, the application server may re-negotiate the session parameters by sending AR session update requests (to the ARSCF, for example), releasing the current AR session, and/or re-establishing a new AR session.

In one approach, UE may detect, via a user plane API, a user plane congestion and indicate a status with a suggested traffic pattern to a user plane function (UPF) in the MNO/MSO network. The UPF may adjust a traffic pattern based on the suggested traffic pattern. The App server may adjust the traffic pattern for the future packet flows and inform, via the user plane API, the UPF of the new traffic pattern and the potential packet drop precedence for different flows and packet types. The UPF may forward the new information to the UE.

In some embodiments, a system may perform a communication flow (or call flow) on the usage of user plane capabilities in a user plane. At a first step, either UE or an access network (e.g., access nodes) or both may detect user plane congestion, and can indicate/send/notify the congestion status to a user plane function (UPF) in the MNO/MSO core networks. Along with the congestion indication, the UE and/or the access network may indicate the current queue status for low latency flows of an AR session, as well as the suggested traffic pattern to keep the low latency queue as low latency. For example, the UE may detect user plane congestion and send to the UPF a notification including the congestion status, the current low latency low loss scalable throughput (L4S) queue length, and/or suggested traffic pattern updates. The access nodes may detect user plane congestion and send to the UPF a notification including the congestion status, the current LAS queue length, and/or suggested traffic pattern updates.

The serving UPF may by itself be able to adjust the traffic pattern. For example, the UPF may terminate either a cellular user plane protocol in the MNO network or a cable user plane protocol in the MSO network. At a second step, the serving UPF may operate to indicate/send/notify, to the traffic source, the congestion condition and the desired traffic pattern if any to keep the low latency service. For example, the serving UPF may perform user plane congestion detection and can send a notification including aggregated congestion information (based on the congestion detected by the UE, the access nodes, or the UPF), the current L4S queue length, and/or suggested traffic pattern updates.

At a third step, the AR application server may adjust the traffic pattern for the future packet flows, and send/notify the new traffic pattern and the potential packet drop precedence for different flows and packet types to the UPF. In adjusting the traffic pattern, the AR application server may convey/apply/perform granular adjustments in the packet forwarding paths. Granular adjustments may be per application service flow basis (e.g., separate adjustments for voice, video, depth and auxiliary traffic flows) to process higher priority traffic with higher priority when congestion occurs. Lower priority traffic may be dropped. For example, a VoIP traffic flow may have higher priority than a video traffic flow; and a 2D image traffic flow can have higher priority than a 3D image traffic flow. In sending/notifying the new traffic pattern and the potential packet drop precedence, the application server may send, to the UPF, a notification on user plane congestion action including updated traffic patterns and packet drop precedence information.

At a fourth step, the UPF may send/forward the new information (e.g., information on updated traffic patterns and packet drop precedent) to the access network and/or the device (UE). In some embodiments, information on packet drop precedence may not be sent/forwarded to the UE. The information on packet drop precedence may not be necessary for the device itself, because the actual application on the device may coordinate with the device to decide the importance of each of incoming/outgoing packets to/from the device. For example, the UPF may send/forward to the access nodes new information on user plane congestion action including updated traffic patterns and packet drop precedence information. The UPF may send/forward to the UE new information on user plane congestion action including information on updated traffic patterns but without packet drop precedence information.

In one approach, a wireless device may include at least one processor and a communication interface configured to communicate with a server device. The at least one processor and the communication interface may send to a service control function (e.g., AR Service Control Function (ARSCF)), through a control plane application program interface (API), a first service request for initiating a service. The first service request may include an address of the server device and first quality of service (QoS) information relating to the service. The at least one processor and the communication interface may receive from the service control function, through the control plane API, a first session request for establishing a session relating to the service. The first session request may be initiated by the server device and include negotiated QoS information relating to the session.

In one approach, in response to the first session request, the at least one processor and the communication interface may be configured to send a session response indicating that the session has been established according to the first session request.

In one approach, in sending the first service request, the at least one processor and the communication interface may be configured to send the first service request to a management function, the first service request causing the management function to generate a second service request including second QoS information based at least on the first QoS information included in the first service request and to send the second service request to the ARSCF. The second service request may cause the ARSCF to generate a third service request including third QoS information based at least on the second QoS information included in the second service request and to send the third service request to the server device. The third service request may cause the server device to determine the negotiated QoS information based at least on the third QoS information included in the third service request.

In one approach, in sending the service request, the at least one processor and the communication interface may be configured to send the first service request directly to the server device, the first service request causing the server device to generate a second session request including the first QoS information included in the first service request and to send the second session request to the ARSCF. The second session request may cause the ARSCF to generate a third session request including the first QoS information included in the second session request and to send the third session request to a management function. The third session request may cause the management function to generate the first session request including the negotiated QoS information based at least on the first QoS information included in the third session request and to send the first session request to the wireless device.

In one approach, the at least one processor may be configured to detect user plane congestion. The at least one processor may be configured to determine a traffic pattern update based at least on the detected user plane congestion. The at least one processor and the communication interface may be configured to send, through a user plane function (UPF) to the server device, a first notification relating to the traffic pattern update. The first notification may cause the server device to generate a new traffic pattern based at least on the traffic pattern update and to send, through the UPF to the wireless device, a second notification relating to the new traffic pattern.

Embodiments in the present disclosure have at least the following advantages and benefits. First, embodiments in the present disclosure can provide useful techniques for an OTT application to negotiate with a network and a server to support low latency QoS (quality of service) by establishing a signaling service between a device with an OTT application thereon (UE), the network, and an OTT application server (or “app server”). Using the systems and methods described herein, the overall QoS requirements/policies for the OTT application can be negotiated, thereby providing a guaranteed/improved bandwidth and latency for a desired period of time.

Second, embodiments in the present disclosure can provide useful techniques for providing a user plane API that plans routing and can manage congestion avoidance, packet drop precedence and low latency queuing to react to network conditions in real time. In some embodiments, a system may utilize a transport protocol standard and extension headers to convey granular adjustments in the packet forwarding paths. The system may drop traffic based on a priority of the traffic (e.g., a lower priority traffic may be dropped).

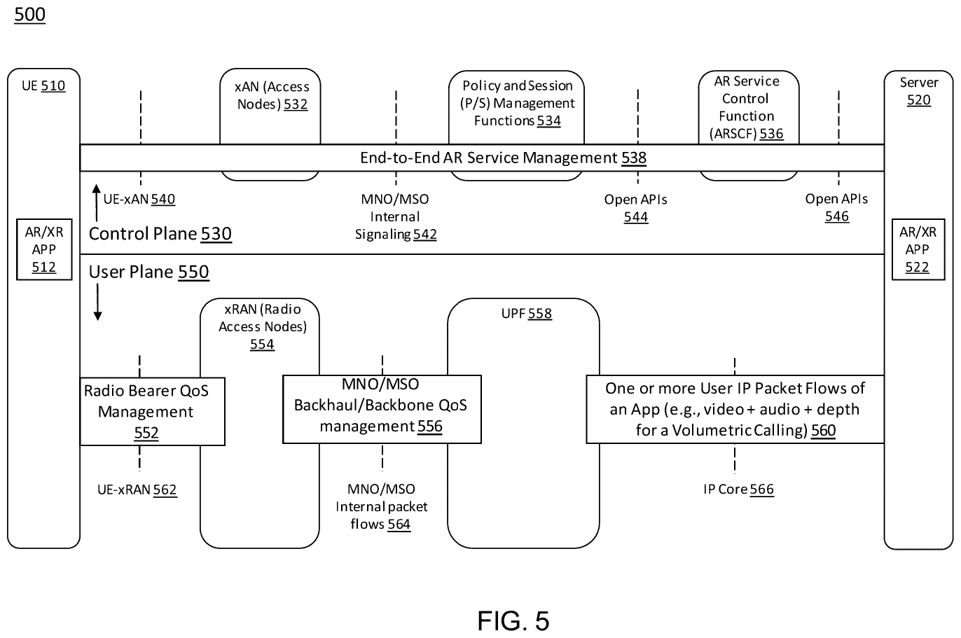

FIG. 5 is a diagram of an example communication system 500 between a wireless device (e.g., UE 510) and a server device (e.g., server 520), according to an example implementation of the present disclosure. Referring to FIG. 5, in a control plane 530, the system 500 may include a service control function (e.g., AR Service Control Function (ARSCF) 536) which can sit or be located at the boundary of a MNO/MSO network between the MNO/MSO network and an application service domain. The ARSCF 536 may communicate with the server device or other network functions (e.g., P/S managements 534) through APIs (e.g., open APIs 544, 546). The ARSCF may be managed or implemented by either an MNO/MSO or an application service provider or even a third party broker. At one side, the ARSCF 536 may interface with policy and session management functions (e.g., P/S managements 534) of MNO/MSO to manage services (e.g., AR/XR services) inside the MNO/MSO network. On the other side, the ARSCF 536 may interface with application functions (e.g., AR/XR application 522) to manage the services between a MNO/MSO network and an application domain (e.g., AR/XR application domain).

In some embodiments, in the control plane 530, the UE 510 and/or an AR/XR application 512 running on the UE 510 may perform end-to-end AR service management 538 with the application server 520 and/or an AR/XR application 522 running on the application server 520. The end-to-end AR service management 538 may be performed by communications between the UE 510, access nodes 532, P/S management 534, ARSCF 536, and the application server 520. The UE 510 may communicate with the access nodes 532 using a signaling/interface 540 between the UE and the access nodes. The access nodes 532 may communicate with the P/S management 534 using an internal signaling/interface 542 in the MNO/MSO network. The P/S management 534 may communicate with the ARSCF 536 using open APIs 544. The ARSCF 536 may communicate with the application server 520 using open APIs 546.

In some embodiments, in a user plane 550, during information data transmission phases (e.g., transmission of AR/XR information/data) the system 500 may perform a quick and efficient method to plan routing, and/or manage congestion avoidance, packet drop precedence and/or low latency queuing, in response to the network conditions in real time. The user plane method may be performed/implemented based on an IP network layer. In some embodiments, the user plane method may be performed/implemented based on a transport layer. The user plane method may be provided/implemented as APIs. In the user plane 550, the UE 510 and/or the AR/XR application 512 running on the UE 510 may perform radio bearer QoS management 552 with radio access points (e.g., RANs 554) using a signaling/interface 562 between the UE 510 and the radio access nodes 554. The radio access nodes 554 may perform MNO/MSO backhaul/backbone QoS management 556 with a user plane function (UPF) 558 through MNO/MSO internal packet flows 564. The UPF 558 may transmit/receive one or more IP packet flows 560 to/from the application server 520 (and the AR/XR application 522 running thereon) using an IP core network 566. The one or more IP packet flows 560 may include traffic of video, audio, depth for a volumetric call.

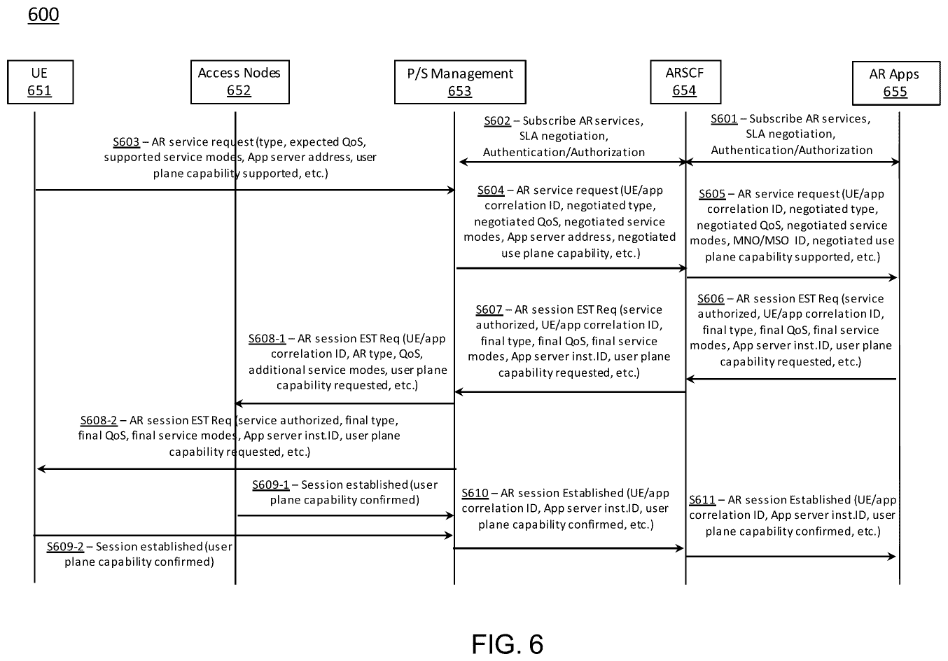

FIG. 6 is a diagram of an example communication flow 600 for service management in a control plane, according to an example implementation of the present disclosure. Referring to FIG. 6, UE 651 may initiate an AR session by sending an AR service request with an expected QoS to a policy/session management function (P/S management 653). The P/S management 653 may send an AR service request with a negotiated QoS to an ARSCF 654. The=ARSCF 654 may send an AR service request with a further negotiated QoS to an application server (e.g., AR application server 655). The application server may send an AR session establishment request with a finally negotiated QoS to the ARSCF 654. The ARSCF 654 may forward the AR session establishment request with the finally negotiated QoS to the P/S management 653. The P/S management 653 may send the AR session establishment request to establish the AR session to the UE 651 through access nodes 652.

In some embodiments, a system may perform the communication flow 600 (or call flow) for initiating an AR service and an AR service session in a control plane. At step S601, in order to initiate and deliver AR services over an MNO/MSO network with an expected/desired QoS, application servers (e.g., AR application server 655) may operate to register/subscribe to neighbor ARSCFs (e.g., ARSCF 654) based on previously known or predetermined relations. Registration/subscription of AR applications may include registration/subscription of AR service types, AR use cases supported, expected QoS ranges for different use cases, server authentication token, authentication methods, server locality, etc. For example, the ARSCF 654 and an AR application running on the application server 655 may perform registration/subscription based on subscribed AR services, service level agreement (SLA) negotiation, authentication/authorization between the ARSCF 654 and the AR application. As a result of the registration/subscription, the ARSCF 654 and the AR application 655 can obtain/achieve an SLA for each AR service type/use case, as well as a trusted relation between the ARSCF and the AR application (or the application server).

At step S602, ARSCFs (e.g., ARSCF 654) may register/subscribe with P/S managements (e.g., P/S management 653) inside the MNO/MSO network. Registration/subscription of ARSCFs may include registration/subscription of AR service types, AR use cases supported, expected QoS ranges for different use cases, ARSCF authentication token, authentication methods, ARSCF locality, etc. For example, the ARSCF 654 and the P/S management 653 may perform registration/subscription based on subscribed AR services, service level agreement (SLA) negotiation, authentication/authorization between the P/S management 653 and the ARSCF 644. As a result of the registration/subscription, the ARSCF 654 and the P/S management 653 can obtain/achieve an SLA for each AR service type/use case, as well as a trusted relation between the ARSCF 654 and the P/S management 653.

At step S603, the UE 651 may initiate an AR session by sending an AR service request to the P/S management 653. The AR service request may include an AR service type, an expected QoS, supported service modes, an address of the application server, one or more user plane capabilities supported, etc. The supported service modes can be different resolution levels that the UE app (e.g., AR application running on the UE 651) supports during the AR session in order to adapt the network conditions. In some embodiments, the supported service modes can include other user traffic adaptive information. The application server address can be information configured on the UE 651 or information obtained by causing the network to detect/discover/figure out the “best” application servers based on server availability, the AR service type, the expected QoS, the supported service modes, and/or the one or more user plane capabilities supported. The one or more user plane capabilities supported can refer to those capabilities that can indicate, for example, capabilities for supporting (1) DiffServ, (2) explicit congestion notification, (3) low latency low loss scalable throughput (L4S) architecture, (4) traffic pattern updates in the user plane, and so on. The traffic pattern updates can be done by defining an optional IP header or a new Internet Control Message Protocol (ICMP) message exchange procedure defined by standards communities.

At step S604, the serving P/S management 653 may decide/determine a common set of capabilities and service modes between the UE 651 and the MNO/MSO network (see FIG. 4), based on the MNO/MSO network policies, session policies, network QoS capabilities, network user plane capabilities, and/or network AR supportability. Next, the P/S management 653 may send an AR service request to a selected/chosen ARSCF 654. The AR service request may include a UE/app (e.g., AR application) correlation identifier (ID), a negotiated service type, a negotiated QoS, negotiated service modes, the address of the application server 655, negotiated one or more user plane capabilities, and so on. The ARSCF 654 can be selected/chosen based on the application server address from the UE 651 or a network configuration. The UE/app correlation ID may be used in future by the ARSCF 654 and the application server 655 (or application server instance) to correlate any future updates for serving the UE/app in this AR session.

At step S605, the ARSCF 654 may decide/determine a common set of capabilities and service modes between the UE 651 and the MNO/MSO network based on local policies of the ARSCF 654, known/predetermined network QoS capabilities, known/predetermined network user plane capabilities, known/predetermined network AR supportability, and so on. Next, the ARSCF 654 may send an AR service request to a selected/chosen application server 655 (or a domain thereof). The AR service request may include the UE/app correlation ID, a negotiated service type, a negotiated QoS, negotiated service modes, an MNO/MSO identifier (ID), negotiated one or more user plane capabilities supported, and so on. The application server 655 can be selected/chosen based on the application server address from the UE 651 or previous server registration/subscription records. The UE/App correlation ID may be used in future by the ARSCF 654 and the serving application server 655 (or application server instance) to correlate any future updates for serving the UE/app in this AR session. The MNO/MSO ID can be used to provide an application service provider (of the AR application) with information on which MNO/MSO is serving the UE AR session at this moment (e.g., when the ARSCF 654 sends the AR service request to the application server 655). The MNO/MSO ID can be useful for tracing records and service stats analysis.

At step S606, the application server 655 may determine whether to authorize the AR service, and in response to determining that the application server authorizes the AR service, the application server 655 may request that the network (e.g., MNO/MSO network) establish the AR session with final negotiated QoS information, the negotiated service modes to be used in the session, the negotiated user plane capabilities to be used in the AR session, etc. The application server 655 may send an AR session establishment (EST) request to the ARSCF 654. The AR session EST request may include a service that is authorized, the UE/app correlation ID, a final negotiated service type, a final negotiated QoS, final negotiated service modes, an identifier (ID) of an application server instance, user plane capability requested, etc. The application server instance ID can identify the actual server instance that is assigned for this AR session. The application server instance ID can be used for tracing records and service stats analysis.

At step S607, the ARSCF 654 may send/forward an AR session establishment (EST) request to the serving P/S management 653. The AR session EST request may include the authorized service, the UE/app correlation ID, the final negotiated service type, the final negotiated QoS, the final negotiated service modes, the application server instance ID, the user plane capability requested, etc. The application server instance ID may be recorded down for further communications. Information on detailed QoS assignments, user plane capabilities to be used and other AR use cases related parameters (e.g., parameters of the AR session EST request) may be used by the device (e.g., UE 651) and underlying network functions to serve the AR session.

At step S608, the P/S management 653 may request that the access network (e.g., access nodes 652) and the UE 651 establish the AR session with the final negotiated QoS information, the service modes to be used in the AR session, the user plane capabilities to be used in the AR session, etc. For example, the P/S management 653 may send to the access nodes 652 an AR session EST request including the UE/app correlation ID, the final negotiated AR service type, the final negotiated QoS, additional service modes as finally negotiated, the user plane capability requested, etc. (see step S608-1). The P/S management 653 may send to the UE 651 an AR session EST request including the AR service authorized, the final negotiated AR service type, the final negotiated QoS, the final service modes, the application server instance ID, the user plane capability requested, etc. (see step S608-2).

At step S609, the access network (e.g., access nodes 652) and the UE 651 may confirm the AR session setup and the user plane capabilities to be used, and can send the confirmation to the P/S management 653. For example, the access nodes 652 may send a session establishment confirmation indicating that user plane capability (e.g., the user plane capability requested) is confirmed (see step S609-1). The UE 651 may send a session establishment confirmation indicating that user plane capability (e.g., the user plane capability requested) is confirmed (see step S609-2). At step S610, the P/S management 653 may confirm the session AR session setup and the user plane capabilities to be used, and can send to the ARSCF 654 a confirmation indicating that the AR session is established with the UE/app correlation ID, the application server instance ID, the user plane capability confirmed. At step S610, the ARSCF 654 may confirm the session AR session setup and the user plane capabilities to be used, and send to the application server instance a confirmation indicating that the AR session is established with the UE/app correlation ID, the application server instance ID, and/or the user plane capability that is confirmed.

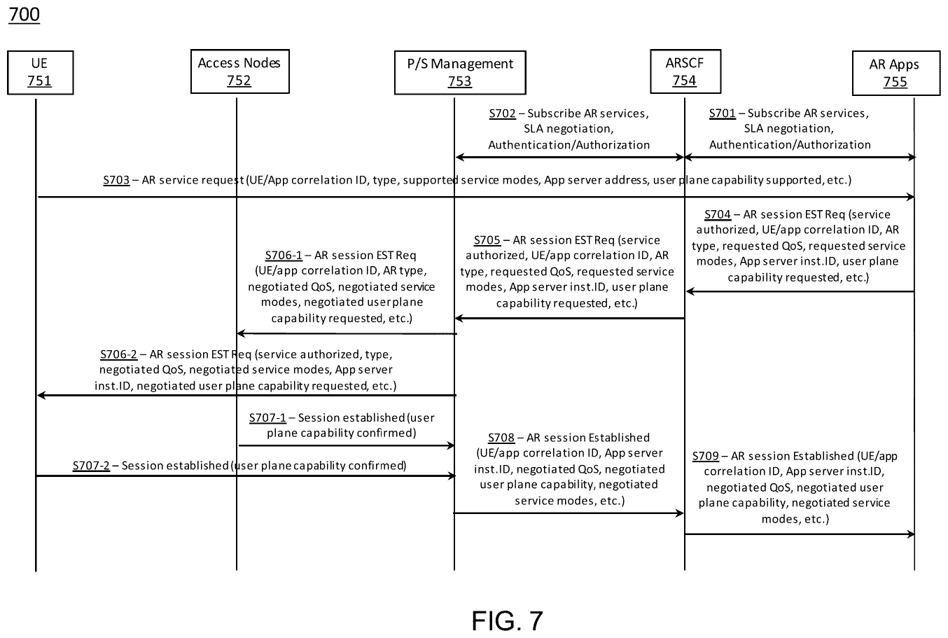

FIG. 7 is a diagram of an example communication flow 700 for service management in a control plane, according to another example implementation of the present disclosure. Referring to FIG. 7, UE 751 may initiate an AR session by sending an AR service request directly to an application server 755. The application server 755 may send an AR session establishment request with a requested QoS to a service control function (e.g., ARSCF 754). The service control function may forward the AR session establishment request with the requested QoS to a P/S management 753. The P/S management 753 may send the AR session establishment request with a negotiated QoS to establish the AR session to the UE 751 through access nodes 752.

In some embodiments, a system may perform the communication flow 700 for initiating an AR service and an AR service session in a control plane. The AR service may be initialized between the application server 755 and the ARSCF 754 at step S701. Step S701 may be performed in a manner similar to that of step S601 (see FIG. 6). The AR service may be initialized between the ARSCF 754 and the P/S management 753 at step S702. Step S702 may be performed in a manner similar to that of step S602 (see FIG. 6).

Referring to FIG. 7, at step S703, the UE 751 may initiate an AR session by sending an AR service request directly to the AR application server 755. The AR service request may include a set of parameters including a UE/app (e.g., AR application) correlation identifier (ID), an AR service type, supported service modes, an address of the application server 755, one or more user plane capabilities supported, etc. The set of parameters may be derived by the UE 751. The UE/App correlation ID may be used by the application server 755 and the network (e.g., MNO/MSO network) to correlate the AR service request by the UE 751 in the subsequent messages. The supported service modes can be different resolution levels that the UE app (e.g., AR application running on the UE 751) supports during the AR session in order to adapt the network conditions. In some embodiments, the supported service modes can include other user traffic adaptive information. The application server address can be information configured on the UE 751. The one or more user plane capabilities supported can refer to those capabilities that can indicate, for example, capabilities for supporting (1) DiffServ, (2) explicit congestion notification, (3) low latency low loss scalable throughput (L4S) architecture, (4) traffic pattern updates in the user plane, and so on. The traffic pattern updates can be done by defining an optional IP header or a new ICMP message exchange procedure.

At step S704, the application server 755 may determine whether to authorize the AR service, and in response to determining that the application server 755 authorizes the AR service, the application server 755 may request that the network (e.g., MNO/MSO network) establish the AR session with requested QoS information, requested service modes to be used in the session, requested user plane capabilities to be used in the AR session, etc. The application server 755 may send an AR session establishment (EST) request to the ARSCF 754. The AR session EST request may include a service authorized, the UE/app correlation ID, the requested service type, the requested QoS, the requested service modes, an identifier (ID) of an application server instance, the requested user plane capability, etc. The application server instance ID can identify the actual server instance that is assigned for this AR session. The application server instance ID can be used for tracing records and service stats analysis.

At step S705, the ARSCF 754 may send/forward an AR session establishment (EST) request to the serving P/S management 753. The AR session EST request may include the service authorized, the UE/app correlation ID, the requested AR service type, the requested QoS, the requested service modes, the application server instance ID, the user plane capability requested, etc. The application server instance ID may be recorded down for further communications. But information on the requested QoS, the requested user plane capabilities, and other AR use cases related parameters (e.g., parameters of the AR session EST request) may be used by the UE 751 and underlying network functions to serve the AR session.

At step S706, the P/S management 753 may request that the access network (e.g., access nodes 752) and the UE 751 establish the AR session with the negotiated QoS information to be used in the AR session, the negotiated service modes to be used in the AR session, the negotiated user plane capabilities to be used in the AR session, etc. For example, the P/S management 753 may send to the access nodes 752 an AR session EST request including the UE/app correlation ID, the AR service type, the negotiated QoS, the negotiated service modes, the user plane capability requested, etc. (see step S706-1). The P/S management 753 may send to the UE 751 an AR session EST request including the AR service authorized, the AR service type, the negotiated QoS, the service modes, the application server instance ID, the user plane capability requested, etc. (see step S706-2). These negotiated parameters may be based on (1) the parameters requested by the application server 755 and/or (2) local policies inside the P/S management 753. In some embodiments, the P/S management 753 may continue setting up the AR session first with the above-noted negotiated parameters to speed up the AR session establishment process. The P/S management 753 may let/cause the application running on the UE 751 and the application running on the application server 755 to decide whether the negotiated parameters are acceptable or not. Alternatively, the P/S management 753 may negotiate directly with the application server 755 back and forth before setting up the AR session in the network. In this case, however, the AR session setup may be delayed.

At step S707, the access network (e.g., access nodes 752) and the UE 751 may confirm the AR session setup and the user plane capabilities to be used, and can send the confirmation to the P/S management 753. If the UE 751 does not accept the negotiated parameters in this step, the UE 751 may reject the AR session establishment and does not send a confirmation to the P/S management 753. For example, the access nodes 752 may send a session establishment confirmation indicating that user plane capability (e.g., the user plane capability requested) is confirmed (see step S707-1). The UE 751 may send a session establishment confirmation indicating that user plane capability (e.g., the user plane capability requested) is confirmed (see step S707-2). At step S708, the P/S management 753 may confirm the session AR session setup and the user plane capabilities to be used, and can send to the ARSCF 754 a confirmation indicating that the AR session is established with the UE/app correlation ID, the application server instance ID, negotiated QoS, negotiated user plane capability, negotiated service modes, etc. The AR session establishment confirmation may include the negotiated parameters to inform the application server 755 of what is established currently.

At step S709, the ARSCF 754 may confirm the session AR session setup and the user plane capabilities to be used, and can send to the application server instance a confirmation indicating that the AR session is established with the UE/app correlation ID, the application server instance ID, a negotiated QoS, negotiated one or more user plane capabilities, negotiated service modes, etc. In some embodiments, at this stage, the application server 755 may decide/determine whether the negotiated session parameters are acceptable or not. If the application server 755 does not determine that the negotiated session parameters are acceptable, the application server 755 may re-negotiate the session parameters by sending AR session update requests (to the ARSCF 754, for example), releasing the current AR session, and/or re-establishing a new AR session.

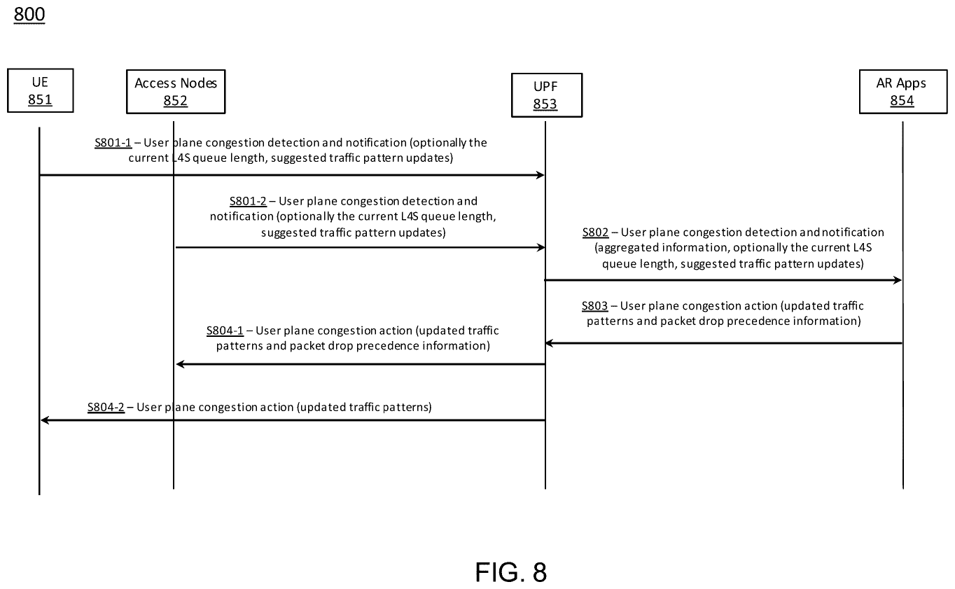

FIG. 8 is a diagram of an example communication flow (or call flow) 800 on the usage of user plane capabilities in a user plane, according to an example implementation of the present disclosure. Referring to FIG. 8, UE 851 may detect, via a user plane API, a user plane congestion and can indicate a status with a suggested traffic pattern to a user plane function (UPF) 853 in the MNO/MSO network. The UPF 853 may adjust a traffic pattern based on the suggested traffic pattern. An application server 854 may adjust the traffic pattern for the future packet flows and inform, via the user plane API, the UPF 853 of the new traffic pattern and the potential packet drop precedence for different flows and packet types. The UPF may forward the new information to the UE 851 or access network (e.g., access nodes 852).

At step S801, either the UE 851 or the access nodes 852 or both may detect user plane congestion, and can indicate/send/notify the congestion status to the UPF 853 in the MNO/MSO core networks. Along with the congestion indication, the UE 851 and/or the access nodes 852 may indicate the current queue status for low latency flows of an AR session, as well as the suggested traffic pattern to keep the low latency queue as low latency. For example, the UE 851 may detect user plane congestion and can send to the UPF 853 a notification including the congestion status, the current low latency low loss scalable throughput (LAS) queue length, and/or suggested traffic pattern updates (see step S801-1). The access nodes 852 may detect user plane congestion and can send to the UPF 853 a notification including the congestion status, the current LAS queue length, and/or suggested traffic pattern updates (see step S801-2).

The serving UPF 853 may by itself be able to adjust the traffic pattern. For example, the UPF 853 may terminate either a cellular user plane protocol in the MNO network or a cable user plane protocol in the MSO network. At step S802, the serving UPF 853 may operate to indicate/send/notify, to the traffic source (e.g., application server 854), the congestion condition and the desired traffic pattern if any to keep the low latency service. For example, the serving UPF 853 may perform user plane congestion detection and can send a notification including aggregated congestion information (based on the congestion detected by the UE 851, the access nodes 852, or the UPF 853), the current LAS queue length, and/or suggested traffic pattern updates.

At step S803, the AR application server 854 may adjust the traffic pattern for the future packet flows, and can send/notify the new traffic pattern and the potential packet drop precedence for different flows and packet types to the UPF 853. In adjusting the traffic pattern, the AR application server 854 may convey/apply/perform granular adjustments in the packet forwarding paths. Granular adjustments may be per application service flow basis (e.g., separate adjustments for voice, video, depth and auxiliary traffic flows) to process higher priority traffic with higher priority when congestion occurs. Lower priority traffic may be dropped. For example, a VoIP traffic flow may have higher priority than a video traffic flow; and a 2D image traffic flow can have higher priority than a 3D image traffic flow. In sending/notifying the new traffic pattern and the potential packet drop precedence, the application server 854 may send, to the UPF 853, a notification on user plane congestion action including updated traffic patterns and/or packet drop precedence information.

At step S804, the UPF 853 may send/forward the new information (e.g., information on updated traffic patterns and packet drop precedent) to the access nodes 852 and/or the UE 851. In some embodiments, information on packet drop precedence may not be sent/forwarded to the UE 851. The information on packet drop precedence may not be necessary for the device itself, because the actual application on the UE 851 may coordinate with the UE 851 to decide the importance of each of incoming/outgoing packets to/from the UE 851. For example, the UPF 853 may send/forward to the access nodes 852 new information on user plane congestion action including updated traffic patterns and packet drop precedence information (see step S804-1). The UPF 853 may send/forward to the UE 851 new information on user plane congestion action including information on updated traffic patterns but without packet drop precedence information (see step S804-2).

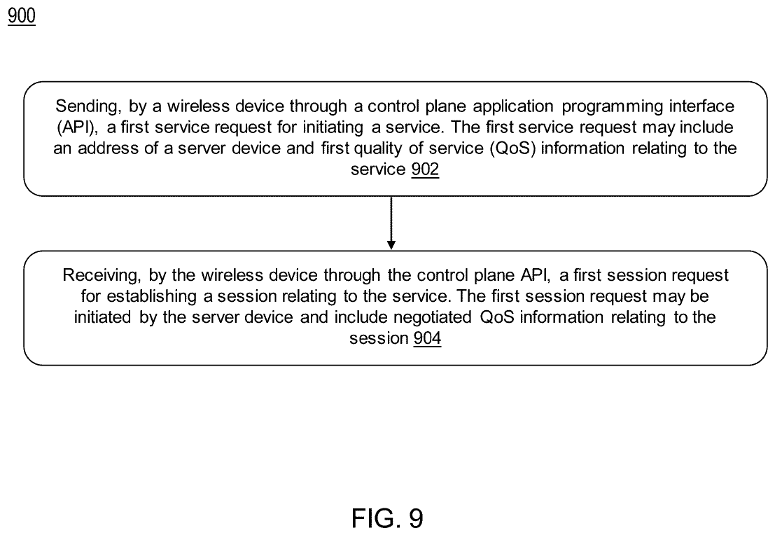

FIG. 9 is a flowchart showing a process 900 for an application to negotiate with a network and a server to support low latency QoS, according to an example implementation of the present disclosure. In some embodiments, the process 900 is performed by a wireless device (e.g., UE 401, UE 510, UE 651, UE 751, UE 851) including at least one processor and a communication interface configured to communicate with a server device (e.g., application servers 520, 655, 755, 854). In some embodiments, the process 900 is performed by other entities. In some embodiments, the process 900 includes more, fewer, or different steps than shown in FIG. 9.

In one approach, the wireless device (e.g., UE 651, UE 751) may send 912, through an ARSCF 536, 654, 754, a first service request (see steps S603, S703) for initiating a service (e.g., AR service). The first service request may include an address of a server device (e.g., application servers 520, 655, 755, 854) and first quality of service (QoS) information relating to the service.

In some embodiments, referring to FIG. 6, in sending the first service request, the wireless device (e.g., UE 651) may send the first service request to a management function (e.g., P/S management 653) (see step S604), the first service request causing the management function to generate a second service request including second QoS information based at least on the first QoS information included in the first service request and send the second service request to the ARSCF 654 (see step S604). The second service request may cause the ARSCF to generate a third service request including third QoS information based at least on the second QoS information included in the second service request and send the third service request to the server device (e.g., application server 655) (see step S605). The third service request may cause the server device to determine the negotiated QoS information based at least on the third QoS information included in the third service request.

In some embodiments, referring to FIG. 7, in sending the service request, the wireless device (e.g., UE 751) may send the first service request directly to the server device (e.g., application server 755) (see step S703), the first service request causing the server device to generate a second session request including the first QoS information included in the first service request and send the second session request to the ARSCF 754 (see step S704). The second session request may cause the ARSCF 754 to generate a third session request including the first QoS information included in the second session request and can send the third session request to a management function (e.g., P/S management 753) (see step S705). The third session request may cause the management function to generate the first session request including the negotiated QoS information based at least on the first QoS information included in the third session request and can send the first session request to the wireless device (e.g., UE 751) (see step S706-2).

In one approach, the wireless device (e.g., UE 651, UE 751) may receive 914, through the ARSCF 654, 754, a first session request for establishing a session relating to the service (see steps S608-2, S706-2). The first session request may be initiated by the server device and include negotiated QoS information relating to the session. In some embodiments, in response to the first session request, the wireless device (e.g., UE 651, UE 751) may send a session response indicating that the session has been established according to the first session request (see steps S609-2, S707-2).

In some embodiments, referring to FIG. 8, the wireless device (e.g., UE 851) may detect user plane congestion. The wireless device may determine a traffic pattern update based at least on the detected user plane congestion. The wireless device may send, through a user plane function (UPF) (e.g., UPF 853) to the server device (e.g., application server 854), a first notification relating to the traffic pattern update (see steps S801, S802). The first notification may cause the server device to generate a new traffic pattern based at least on the traffic pattern update and can send, through the UPF to the wireless device, a second notification relating to the new traffic pattern (see steps S803, S804-2).

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A wireless device comprising:
at least one processor and a communication interface configured to communicate with a server device to:
send, through a service control function, a first service request for initiating a service, wherein the first service request includes an address of the server device and first quality of service (QoS) information relating to the service; and
receive, through the service control function, a first session request for establishing a session relating to the service, wherein the first session request is initiated by the server device and includes negotiated QoS information relating to the session.

2. The wireless device of claim 1, wherein in response to the first session request, the at least one processor and the communication interface are configured to send a session response indicating that the session has been established according to the first session request.

3. The wireless device of claim 1, wherein in sending the first service request, the at least one processor and the communication interface are configured to:
send the first service request to a management function, the first service request causing the management function to generate a second service request including second QoS information based at least on the first QoS information included in the first service request and send the second service request to the service control function.

4. The wireless device of claim 3, wherein the second service request causes the service control function to generate a third service request including third QoS information based at least on the second QoS information included in the second service request and send the third service request to the server device.

5. The wireless device of claim 4, wherein the third service request causes the server device to determine the negotiated QoS information based at least on the third QoS information included in the third service request.

6. The wireless device of claim 1, wherein in sending the service request, the at least one processor and the communication interface are configured to:
send the first service request directly to the server device, the first service request causing the server device to generate a second session request including the first QoS information included in the first service request and send the second session request to the service control function.

7. The wireless device of claim 6, wherein the second session request causes the service control function to generate a third session request including the first QoS information included in the second session request and send the third session request to a management function.

8. The wireless device of claim 7, wherein the third session request causes the management function to generate the first session request including the negotiated QoS information based at least on the first QoS information included in the third session request and send the first session request to the wireless device.

9. The wireless device of claim 1, wherein the at least one processor and the communication interface are configured to:
detect user plane congestion;
determine a traffic pattern update based at least on the detected user plane congestion; and
send, through a user plane function (UPF) to the server device, a first notification relating to the traffic pattern update.

10. The wireless device of claim 9, wherein the first notification causes the server device to generate a new traffic pattern based at least on the traffic pattern update and send, through the UPF to the wireless device, a second notification relating to the new traffic pattern.

11. A method comprising:
sending, by a wireless device through a service control function, a first service request for initiating a service, wherein the first service request includes an address of a server device and first quality of service (QoS) information relating to the service; and
receiving, by the wireless device through the service control function, a first session request for establishing a session relating to the service, wherein the first session request is initiated by the server device and includes negotiated QoS information relating to the session.

12. The method of claim 11, further comprising:
in response to the first session request, sending a session response indicating that the session has been established according to the first session request.

13. The method of claim 11, wherein sending the first service request comprises:
sending the first service request to a management function, the first service request causing the management function to generate a second service request including second QoS information based at least on the first QoS information included in the first service request and send the second service request to the service control function.

14. The method of claim 13, wherein the second service request causes the service control function to generate a third service request including third QoS information based at least on the second QoS information included in the second service request and send the third service request to the server device.

15. The method of claim 14, wherein the third service request causes the server device to determine the negotiated QoS information based at least on the third QoS information included in the third service request.

16. The method of claim 11, wherein sending the service request comprises:
sending the first service request directly to the server device, the first service request causing the server device to generate a second session request including the first QoS information included in the first service request and send the second session request to the service control function.

17. The method of claim 16, wherein the second session request causes the service control function to generate a third session request including the first QoS information included in the second session request and send the third session request to a management function.

18. The method of claim 17, wherein the third session request causes the management function to generate the first session request including the negotiated QoS information based at least on the first QoS information included in the third session request and send the first session request to the wireless device.

19. The method of claim 11, further comprising:
detecting user plane congestion;
determining a traffic pattern update based at least on the detected user plane congestion; and
sending, through a user plane function (UPF) to the server device, a first notification relating to the traffic pattern update.

20. The method of claim 19, wherein the first notification causes the server device to generate a new traffic pattern based at least on the traffic pattern update and send, through the UPF to the wireless device, a second notification relating to the new traffic pattern.
